(19) United States
(12) Patent Application Publication
(10) Pub. No.: US 2005/0099902 A1
(43) Pub. Date: May 12, 2005

(54) Method of correcting a step number of a stepping motor in an optical drive

(75) Inventors: Hsiang-Yi Fu, Taipei (TW); Fu-Hsiang Chen, Taipei (TW); Jen-Yu Hsu, Taipei (TW); Tun-Chieh Lee, Taipei (TW); Chi-Feng Chen, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 10/981,578

(22) Filed: Nov. 5, 2004

(30) Foreign Application Priority Data
Nov. 6, 2003 (TW) 92131143

(51) Int. Cl. G11B 7/00

(52) U.S. Cl. 369/44.28; 369/53.25

(57) ABSTRACT

A method of correcting a step number of a stepping motor in an optical drive is disclosed. After an optical disk is tray into the optical drive, a step number of the stepping motor for moving an optical pickup module by a predetermined number of tracks is firstly calculated. Then, a practical track number by which the optical pickup module is moved after the stepping motor has stepped by the step number is calculated. Thereafter, a corrective track/step ratio is obtained.

This application claims the benefit of Taiwan application Serial No. 92131143, filed Nov. 6, 2003, the subject matter of which is incorporated herein by reference.

### BACKGROUND OF THE INVENTION

1. Field of the Invention

The invention relates in general to a method of controlling a stepping motor in an optical drive, and more particularly to a method of correcting a step number of a stepping motor in an optical drive.

2. Description of the Related Art

When an optical drive receives a read/write command outputted from a host, its seeking servo firstly performs the seeking operation, i.e., the operation using a sled motor in the optical drive to move an optical pickup module to a target track identified by the seeking servo. After the optical drive makes sure that the optical pickup module has reached the target track, the operation of accessing the disk is performed. When the optical drive is performing the seeking and accessing operations, the moving speed of the optical pickup module affects the read/write speed of the optical drive.

Typically, the sled motors for moving the optical pickup modules may be divided into two kinds, one of which is a DC motor, and the other of which is a stepping motor. Because the frictional coefficient between the rack and lead screw in the optical pickup module varies with each optical drive, the force of the DC motor for driving the optical pickup module cannot be easily controlled. So, most of the currently used optical drives utilize the stepping motor. Because the stepping motor moves the optical pickup module in a digital manner, the moving time of the optical pickup module in each optical drive does not vary too much.

However, because the optical disk has the processing variation, the optical drive using the stepping motor still cannot precisely move the optical pickup module to the target track.

As shown in FIG. 1, the track pitch in the specification of the optical disk is 1.6 μm. The track pitch of the optical disk with the processing variation becomes 1.7 μm. That is, the distance (the point A to C) of 10000 tracks of the optical disk with the processing variation is quite different from the distance (the point A to B) of 10000 tracks of the standard optical disk, as shown in FIG. 1. The default track/step ratio of the conventional optical disk drive is a constant (for example, 50:1). When a command of seeking 10000 tracks, which is transferred from the host, is received, the stepping motor moves 200 (10000 divided by 50) steps, and drives the optical pickup module to move in the ordinary condition. The optical pickup module is supposed to move 10000 tracks to reach the target track when the stepping motor has stepped by 200 steps. However, due to the track pitch variation of the optical disk, the stepping motor, which moves 200 steps, only drives the optical pickup module to move 9400 tracks, and there are still 600 tracks away from the target track.

The above-mentioned condition is quite disadvantageous to the tracking operation after seeking, and more time has to be spent in the tracking operation. Even worse, the tracking operation may fail due to the optical pickup module is too away from the target track. So, a method of effectively controlling the step number of the stepping motor is needed in an optical drive using the stepping motor for seeking, such that the optical pickup module after seeking can correctly reach the target track.

### SUMMARY OF THE INVENTION

It is therefore an object of the invention to provide a method of correcting a step number of a stepping motor in an optical drive in order to solve the problem of the optical drive incapable of precisely seeking owing to the processing variation of each optical disk.

The invention achieves the above-identified object by providing a method of correcting a step number of a stepping motor in an optical drive. After an optical disk is tray into the optical drive, a step number of the stepping motor for moving an optical pickup module by a predetermined number of tracks is firstly calculated. Then, a practical track number by which the optical pickup module is moved after the stepping motor has stepped by the step number is calculated. Thereafter, a corrective track/step ratio is obtained.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic illustration showing a track pitch error caused by the processing variation of an optical disk.

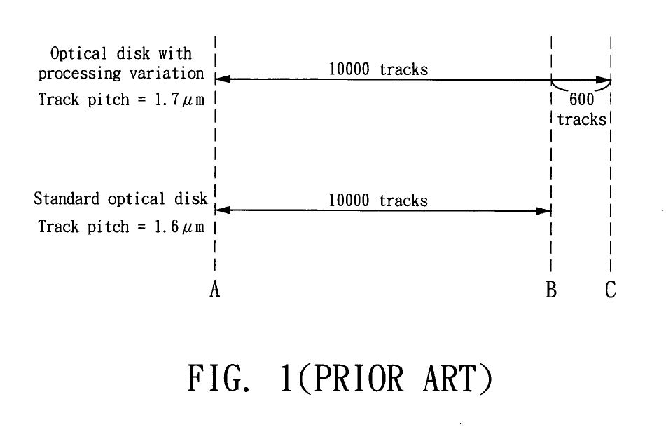

FIG. 2 is a flow chart showing a method of correcting the step number of the stepping motor in the invention.

### DETAILED DESCRIPTION OF THE INVENTION

Because the processing variation of the optical disk makes the track pitches of the individual optical disk different, the sled motor cannot exactly move the optical pickup module to the target track when the optical drive is seeking. The above-mentioned condition is quite disadvantageous to the tracking operation after seeking, and a longer period of time has to be spent for the tracking operation. In order to overcome the above-mentioned problem, the invention proposes a method of correcting the step number of a stepping motor in the optical drive.

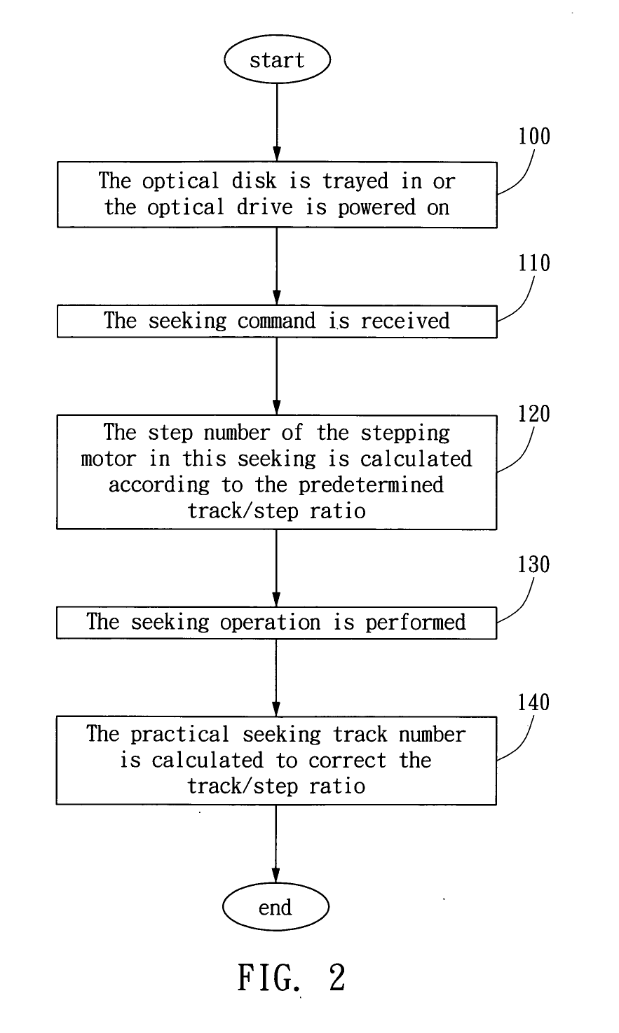

FIG. 2 is a flow chart showing a method of correcting the step number of the stepping motor in the invention. The method includes the following steps.

In the step 100, the disk is trayed into the disk drive or the optical drive is powered on.

In the step 110, a seeking command is received.

In the step 130, the step number of the stepping motor during this seeking operation is calculated according to a predetermined track/step ratio.

In the step 140, the seeking operation is performed.

In step 150, the practical seeking track number to be sought is calculated to correct the track/step ratio.

When the disk is placed into the drive or the optical drive is powered on, the correction procedure is proceeded. When the seeking command outputted from the host is received (it is assumed that the optical pickup module is a distance of 10000 tracks from the target track, and the predetermined track/step ratio of the optical drive is 50:1), the step number of the stepping motor according to this track/step ratio is 200 steps. Then, the seeking operation is performed. That is, the stepping motor is utilized to move the optical pickup module. The practical seeking track number may be calculated by detecting the time position (for example, M:S:F of CD) of the optical disk after the seeking process. If the practical seeking track number is only 9000 tracks, it is concluded that the practical track pitch of this optical disk is longer than that of the standard disk. Thus, the track/step ratio of the optical drive should be adjusted in order to enhance the efficiency of reading the optical disk. The practical seeking track number (9000) is divided by the step number (200) of the stepping motor to obtain the corrective track/step ratio of 45:1. Thereafter, the corrective track/step ratio is always utilized for the seeking when the optical drive is reading the same optical disk, unless the optical drive is powered off or the disk is trayed out.

So, after the optical disk is placed into the optical drive, or the optical drive is powered on and the optical disk does exist, the above-mentioned correction procedure will be proceeded. The track/step ratio may be corrected just as the seeking operation is performed one time.

In addition, the method of using the practical seeking track number to correct the track/step ratio in the invention is more applicable to in the case of long seeking process. At this time, the defined long seeking process here has the seeking track number greater than 10000 tracks. The seeking distance error due to disk variation is smaller and hard to be distinguished during the short seeking process. The seeking distance error due to the disk variation during the long seeking process is more obvious, so the precise track/step ratio may be obtained.

Consequently, the advantage of the invention is to utilize the result of the first seeking process to get the precise track/step ratio. It is possible to make the optical drive more effectively control the seeking precision without many times of corrections during the seeking process.

Furthermore, another advantage of the invention is to effectively decrease the seeking time and overcome the problem of poor access efficiency owing to the processing variation of the optical disk according to the correction procedure.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method of correcting a step number of a stepping motor in an optical drive, comprising the steps of:
(a) calculating a predetermined step number of the stepping motor when an optical pickup module is moved by a predetermined track number; and
(b) obtaining a corrective track/step ratio according to a practical track number moved by the optical pickup module after the stepping motor has stepped by the predetermined step number.

2. The method according to claim 1, wherein the predetermined track number is greater than or equal to 10000.

3. The method according to claim 1, wherein the corrective track/step ratio is obtained by dividing the practical track number by the predetermined step number.

4. The method according to claim 1, wherein the step (a) is performed only when an optical disk is tray into the optical drive.

5. The method according to claim 1, wherein the step (a) is performed only when the optical drive is powered on and an optical disk exists.

6. A method of correcting a step number of a stepping motor in an optical drive, the stepping motor used for driving an optical pickup module, the method comprising the steps of:
(a) driving the stepping motor by a predetermined step number;
(b) calculating a practical track number by which the optical pickup module is moved after the stepping motor has stepped by the predetermined step number; and
(c) obtaining a corrective track/step ratio according to the practical track number and the predetermined step number.

7. The method according to claim 6, wherein the corrective track/step ratio is obtained by dividing the practical track number by the predetermined step number.

8. The method according to claim 6, wherein the step (a) is performed only when an optical disk is tray into the optical drive.

9. The method according to claim 6, wherein the step (a) is performed only when the optical drive is powered on and an optical disk exists.
